(19) United States
(12) Patent Application Publication
(10) Pub. No.: US 2025/0253363 A1
(43) Pub. Date: Aug. 7, 2025

(54) VALVE MODULE AND VALVE ASSEMBLY FOR VEHICLE

(71) Applicants: Hyundai Motor Company, Seoul (KR); Kia Corporation, Seoul (KR)

(72) Inventor: In Tae Park, Hwaseong (KR)

(21) Appl. No.: 18/932,269

(22) Filed: Oct. 30, 2024

(30) Foreign Application Priority Data
Feb. 2, 2024 (KR) 10-2024-0016786

(51) Int. Cl. H01M 8/04082; H01M 8/04746; H01M 8/2484

(52) U.S. Cl. CPC H01M 8/04201; H01M 8/04753; H01M 8/2484; H01M 2250/20

(57) ABSTRACT

A valve module for a vehicle includes a valve holder including a supply passage, through which fluid flows from an inlet, into which the fluid is supplied, a cutoff valve coupled to the valve holder, and that prevents or allow flow of the fluid through the supply passage, and a flow rate control valve coupled to the valve holder, and that controls a flow rate of the fluid that flows through the supply passage.

### CROSS-REFERENCE TO RELATED APPLICATION

This application claims under 35 U.S.C. § 119 (a) the benefit of Korean Patent Application No. 10-2024-0016786, filed in the Korean Intellectual Property Office on Feb. 2, 2024, the entire contents of which are incorporated herein by reference.

### BACKGROUND

### (a) Technical Field

The present disclosure relates to a valve module and a valve assembly for a vehicle such as a fuel cell vehicle.

### (b) Description of the Related Art

Recently, in view of heightened concerns over the environment and depletion of oil resources, research and development on eco-friendly vehicles, such as electric vehicles and fuel cell vehicles, have increased.

A fuel cell vehicle has a power source of a fuel cell that generates electricity through reaction of hydrogen and oxygen, and may include a fuel cell stack and a hydrogen supply system that supplies hydrogen to the fuel cell stack.

The hydrogen supply system may include a valve assembly that receives hydrogen gas and delivers it to a nozzle for injection. Meanwhile, in relation to a valve assembly, a need for a structure that may be provided in various sizes according to a unified valve assembly for various fuel cell vehicles is increasing.

### SUMMARY

An aspect of the present disclosure provides a valve assembly for a vehicle, in which a valve holder and a nozzle holder are manufactured separately, and the valve holder and the nozzle holder may be mounted on a manifold, respectively.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a valve module includes a valve holder including a supply passage, through which fluid flows from an inlet, into which the fluid is supplied, a cutoff valve coupled to the valve holder, and that prevents or allow flow of the fluid through the supply passage, and a flow rate control valve coupled to the valve holder, and that controls a flow rate of the fluid that flows through the supply passage.

The flow rate control valve may be disposed on a downstream side of the cutoff valve with respect to a flow direction of the fluid that flows through the supply passage.

Any one of the cutoff valve or the flow rate control valve may be formed on an opposite side to one side, on which the inlet of the valve holder is provided.

The cutoff valve may be coupled to the valve holder along a first coupling axis, and the flow rate control valve may be coupled to the valve holder along a second coupling axis crossing the first coupling axis.

A direction of the first coupling axis may be perpendicular to a direction of the second coupling axis.

A volume of a portion of the supply passage between the cutoff valve and the flow rate control valve may be configured to be smaller than 20 ml.

According to another aspect of the present disclosure, a valve assembly includes a manifold, a valve holder coupled to the manifold, a nozzle holder seated in the manifold between the valve holder and the manifold, a coupling member that couples the valve holder to the manifold, and a first sealing member that seals an aperture between the valve holder and the nozzle holder.

The manifold may include an inlet hole, into which the nozzle holder is inserted, and a nozzle holder seat protruding from an inner surface extending along a circumference of the inlet hole toward a center of the inlet hole, and that supports the nozzle holder.

The valve holder may include a supply passage provided in an interior of the valve holder such that fluid flows therethrough, the nozzle holder may include a nozzle passage communicated with the supply passage and that delivers the fluid to the nozzle coupled to the nozzle holder, and a communication hole that communicates the supply passage and the nozzle passage, and the nozzle holder or the valve holder may include a first sealing member groove accommodating the first sealing member, and extending to surround a through direction of the communication hole.

The first sealing member groove may be configured to be recessed from a support surface of the nozzle holder, which faces the valve holder.

The valve assembly may further include a second sealing member provided between the manifold and the nozzle holder, and that seals an aperture between the manifold and the nozzle holder.

The manifold may include an inlet hole, into which the nozzle holder is inserted, and the nozzle holder or the manifold may include a second sealing member groove accommodating the second sealing member and extending to surround an extension direction of the inlet hole.

The manifold may include a nozzle holder seat protruding from an inner surface of the manifold, which extends along a circumference of the inlet hole, toward a center of the inlet hole and that supports the nozzle hole, and the second sealing member groove may be formed to be recessed from a contact surface supporting the nozzle holder of the nozzle holder seat.

A vehicle may comprise the valve assembly.

The coupling member may be inserted into the manifold while passing through the valve holder.

A plurality of coupling members may be provided to be coupled to four corner areas of the valve holder when viewed from a top.

The valve holder may include a supply passage provided in an interior of the valve holder such that the fluid flows therethrough, and the valve assembly may further include a cutoff valve coupled to the valve holder and that prevents or allow flow of the fluid through the supply passage, and a flow rate control valve coupled to the valve holder, and that controls a flow rate of the fluid that flows through the supply passage.

The nozzle holder may include a guide boss protruding from a seating surface of the nozzle holder, which faces the nozzle holder seat, toward the nozzle holder seat, and the nozzle holder seat may include a guide groove configured such that the guide boss is inserted thereinto.

The nozzle holder may include a fixing boss protruding from an opposite side to one side, on which the guide boss is provided, in a horizontal direction, and the manifold may include a fixing boss surface defining a fixing boss recess, into which the fixing boss is to be inserted, and that prevents rotation of the fixing boss.

The valve holder may include a supply passage provided in an interior of the valve holder such that the fluid flows therethrough, the nozzle holder may include a nozzle passage communicated with the supply passage and that delivers the fluid to a first nozzle and a second nozzle coupled to the nozzle holder, and the nozzle passage may include a first nozzle passage that delivers the fluid to the first nozzle and a second nozzle passage that delivers the fluid to the second nozzle.

A vehicle may comprise the valve assembly.

### BRIEF DESCRIPTION OF THE DRAWINGS

The above and other objects, features and advantages of the present disclosure will be more apparent from the following detailed description taken in conjunction with the accompanying drawings:

FIG. 1 is a longitudinal cross-sectional view of a valve assembly according to an embodiment of the present disclosure;

FIG. 2 is a plan view of a valve assembly according to an embodiment of the present disclosure;

FIG. 3 is a schematic view of a first sealing member and a second sealing member according to an embodiment of the present disclosure;

FIG. 4 is a longitudinal cross-sectional view of a valve assembly according to another embodiment of the present disclosure;

FIG. 5 is a longitudinal cross-sectional view of a valve assembly according to another embodiment of the present disclosure;

FIG. 6 is a schematic view of a nozzle holder, and a first sealing member and a second sealing member according to embodiment of the present disclosure;

FIG. 7 is a longitudinal cross-sectional view of a nozzle holder taken along line A-A′ illustrated in FIG. 6, which is seated on a manifold;

FIG. 8 is a longitudinal cross-sectional view of a nozzle holder taken along line B-B′illustrated in FIG. 6, which is seated on a manifold;

FIG. 9 is a schematic view of a nozzle holder, and a first sealing member and a second sealing member according to another embodiment of the present disclosure.

FIG. 10 is a longitudinal cross-sectional view of a nozzle holder taken along line C-C′ illustrated in FIG. 9, which is seated on a manifold;

FIG. 11 is a longitudinal cross-sectional view of a nozzle holder taken along line D-D′ illustrated in FIG. 9, which is seated on the manifold;

FIG. 12 is a longitudinal cross-sectional view of a valve assembly according to another embodiment of the present disclosure; and

FIG. 13 is a schematic view of a cutoff valve illustrated in FIG. 12.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, some embodiments of the present disclosure will be described in detail with reference to the attached drawings so that those skilled in the art may easily implement the present disclosure. When adding reference numerals to components in each drawing, it should be noted that identical components are given the same reference numerals as much as possible even if they are shown in different drawings. Additionally, in describing embodiments of the present disclosure, when it is determined that detailed descriptions of related known configurations or functions may impede understanding of the embodiments of the present disclosure, detailed descriptions thereof will be omitted.

Furthermore, in describing the components of the embodiments of the present disclosure, terms, such as first, second, “A”, “B”, (a), and (b) may be used. The terms are simply for distinguishing the components, and the essence, the sequence, and the order of the corresponding components are not limited by the terms. Unless defined differently, all the terms including technical or scientific terms have the same meanings as those generally understood by an ordinary person in the art, to which the present disclosure pertains. The terms, such as the terms defined in dictionaries, which are generally used, should be construed to coincide with the context meanings of the related technologies, and are not construed as ideal or excessively formal meanings unless explicitly defined in the present disclosure.

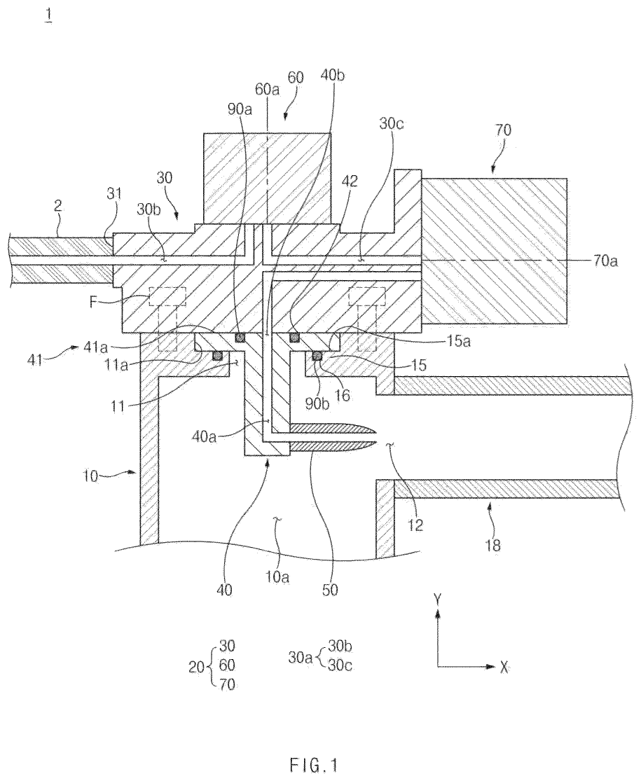

Hereinafter, embodiments of the present disclosure will be described in detail with reference to FIGS. 1 to 13.

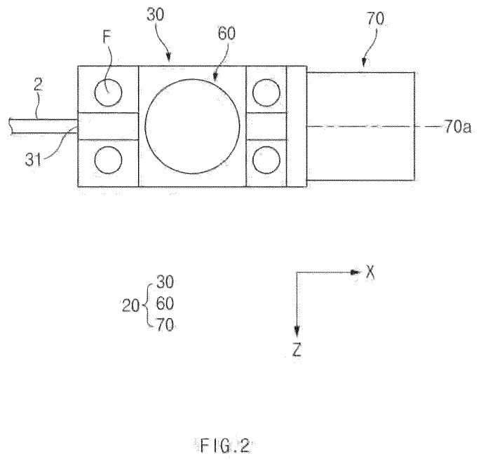

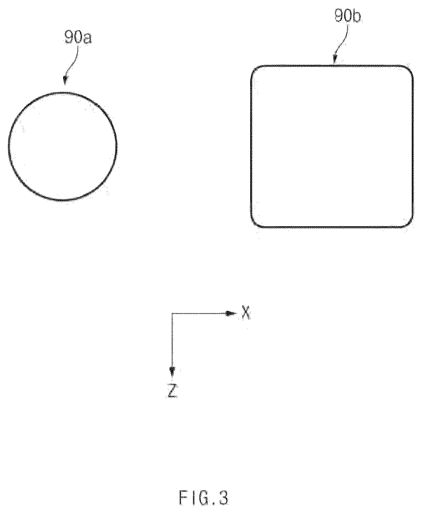

FIG. 1 is a longitudinal cross-sectional view of a valve assembly according to an embodiment of the present disclosure. FIG. 2 is a plan view of the valve assembly according to an embodiment of the present disclosure. FIG. 3 is a schematic view of a first sealing member and a second sealing member according to an embodiment of the present disclosure.

Referring to FIGS. 1 to 3, a fuel cell system may include a storage tank (not illustrated) that is configured to store fluid, and a regulator (not illustrated) for controlling a pressure of the fluid that is supplied from the storage tank.

The fuel cell system may include a valve assembly 1 that receives the fluid, the pressure of which has been through the regulator and supplies it to a fuel cell stack at a necessary flow rate. The fluid hereinafter may be understood as hydrogen gas, but is not limited thereto.

The valve assembly 1 may include a manifold 10 including a manifold passage 10a provided in an interior of the manifold 10, and a diffuser 18 that is mounted on the manifold 10. The valve assembly 1 may be a component for supplying the fluid that is received from the fuel cell and the fluid that is newly supplied from the storage tank back to the fuel cell stack, and the fluid that is received from the fuel cell stack may be accommodated in the manifold passage 10a, and may be supplied to the fuel cell stack together with the newly supplied fluid through the diffuser 18 again.

Furthermore, the valve assembly 1 may include a manifold 10, and a valve module 20 that is coupled to the manifold 10.

The valve module 20 may include a supply passage 30a, through which the fluid from an inlet 31 that receives the fluid from a supply pipeline 2 flows, and may include a valve holder 30 that is coupled to the manifold 10. The supply passage 30a of the valve holder 30 may be a passage that is communicated with the inlet 31, and through which the fluid flows.

The valve module 20 may include a cutoff valve 60 that is coupled to the valve holder 30 to prevent or allow flow of the fluid through the supply passage 30a, and a flow rate control valve 70 that is coupled to the valve holder 30 and is configured to control the flow rate of the fluid that flows through the supply passage 30a.

Furthermore, the valve assembly 1 may include a nozzle 50 that is configured to spray the fluid toward the diffuser 18. The nozzle 50 may extend toward the diffuser 18.

The valve assembly 1 may include a nozzle holder 40, to which the nozzle 50 is coupled. The nozzle holder 40 may include a nozzle passage 40a for delivering the fluid to the nozzle 50 that is configured to spray the fluid toward the diffuser 18. The nozzle passage 40a may be communicated with the supply passage 30a.

The manifold 10 includes an inlet hole 11 into which the nozzle holder 40 is inserted, and an outlet hole 12, in which the diffuser 18 is mounted, and may be provided with a manifold passage 10a between the inlet hole 11 and the outlet hole 12.

The diffuser 18 is configured to supply the fluid sprayed from the nozzle 50 to the fuel cell stack, and the nozzle 50 may be mounted on the nozzle holder 40 to face the outlet hole 12.

The valve holder 30 may receive the fluid through the inlet 31 from the supply pipeline 2 that delivers the fluid, the pressure of which has been reduced by the regulator, and may deliver the fluid to the nozzle holder 40. The cutoff valve 60 that prevents or allows the flow of the fluid through the supply passage 30a, and the flow rate control valve 70 that is configured to control the flow rate of the fluid that flows through the supply passage 30a may be mounted on the valve holder 30.

The valve holder 30 may include the supply passage 30a that receives the fluid from the supply pipeline 2 and is provided in an interior of the valve holder 30 such that the fluid flows to the nozzle holder 40. The supply passage 30a may include a first supply passage 30b that is provided on an upstream side of the cutoff valve 60 with respect to a flow direction of the fluid, and a second supply passage 30c that is provided on a downstream side of the cutoff valve 60 and is provided on upstream side of the flow rate control valve 70.

The second supply passage 30c may be, among the supply passages 30a, a passage between the cutoff valve 60 and the flow rate control valve 70. A volume of the second supply passage 30c may be smaller than 20 ml. According to the above-described structure, a volume of the second supply passage 30c may be reduced, and thus, a size of the valve module 20 may be decreased.

In this way, the flow rate control valve 70 may be disposed on a downstream side of the cutoff valve 60 with respect to the flow direction of the fluid that flows through the supply passage 30a. Furthermore, any one of the cutoff valve 60 or the flow rate control valve 70 may be formed on an opposite side to a side, on which the inlet 31 of the valve holder 30 is provided.

Preferably, the flow rate control valve 70 may be formed on an opposite side to one side of the valve holder 30, on which the inlet 31 is provided. Then, the cutoff valve 60 may be coupled to the valve holder 30 between the inlet 31 of the valve holder 30 and the flow rate control valve 70.

The cutoff valve 60 may be coupled to the valve holder 30 along a first coupling axis 60a on an upper side of the valve holder 30, and the flow rate control valve 70 may be coupled to the valve holder 30 along a second coupling axis 70a on one side of the valve holder 30. Then, the first coupling axis 60a and the second coupling axis 70a may extend to cross each other. In more detail, the first coupling axis 60a and the second coupling axis 70a may be directions that are perpendicular to each other. The supply pipeline 2 may be coupled to the valve holder 30 along a direction that is parallel to the second coupling axis 70a on an opposite other side of the valve holder 30.

In relation to this structural reason, a manufacturing method using a drill or a mold may be used to machine the supply passage 30a that is provided in an interior of the valve holder 30. Then, the supply passage 30a needs to be connected to both of the supply pipeline 2, the cutoff valve 60, and the flow rate control valve 70, and for ease of manufacturing the supply passage 30a using a drill or a mold, the supply pipeline 2, cutoff valve 60, and the flow rate control valve 70 may be mounted on the valve holder 30 in perpendicular directions, respectively.

Furthermore, when the valve holder 30 has a substantially rectangular parallelepiped shape, the manifold 10 is mounted on one surface of the valve holder 30, and thus, the supply pipeline 2, the cutoff valve 60, and the flow rate control valve 70 may be mounted on remaining three other surfaces of the valve holder other than one surface of the valve holder 30 in perpendicular directions. According to this structure, the supply passage 30a of the valve holder 30 may be machined in a straight line, and thus, a machining performance of the supply passage 30a may be easy.

The valve holder 30, the cutoff valve 60, and the flow rate control valve 70 may be formed of an anti-rust material to prevent rust due to exposure to external environments, such as atmospheric moisture or rainwater.

The valve assembly 1 may include a coupling member “F” that is configured to couple the valve holder 30 to the manifold 10. The valve holder 30 may be coupled to the manifold 10 by the coupling member “F”. In more detail, when viewed in a direction, in which the manifold 10 is viewed from the valve holder 30 (an opposite direction to the “Y” direction, a downward direction), the valve holder 30 may be coupled to the manifold 10 and a position thereof may be fixed by four coupling members “F” that are provided along a circumference of the valve holder 30.

A plurality of coupling members “F” may be provided. In more detail, the four coupling members “F” may be provided, and as illustrated in FIG. 2, when viewed from the “Y” direction (an upward direction), they may be inserted into four corner areas of the valve holder 30 on an outside of the cutoff valve 60. The coupling members “F” may be inserted into the manifold 10 through the valve holder 30 at the four corner areas of the valve holder 30.

The nozzle holder 40 may be seated on the manifold 10 between the valve holder 30 and the manifold 10. Unlike the valve holder 30, the nozzle holder 40 may not be coupled to the manifold 10. However, the nozzle holder 40 may be pressed toward the manifold 10 by the valve holder 30, and may be supported by the nozzle holder seat 15 of the manifold 10, and thus, a position thereof may be fixed.

In this way, the manifold 10 may include an inlet hole 11, into which the nozzle holder 40 is inserted, and a nozzle holder seat 15 that protrudes from the inner surface 11a of the manifold 10 that extends along a circumference of the inlet hole 11 toward a center of the inlet hole 11 to support the nozzle holder 40.

According to this structure, even when the valve holder 30 and the nozzle holder 40 are not integrally formed, the nozzle holder 40 may be stably supported by the manifold 10 only by coupling the valve holder 30 and the manifold 10.

To prevent rust from occurring in the nozzle holder 40 due to exposure to a high temperature and a high humidity caused by water vapor accommodated in the manifold passage 10a, the nozzle holder 40 may be formed of a rust-proof material. Unlike the valve holder 30 formed through surface treatment or formed of aluminum, the nozzle holder 40 may always be exposed to water vapor, and the like, and thus, the nozzle holder 40 may be formed of a material with a higher anti-rust performance than the valve holder 30.

Accordingly, according to an embodiment of the present disclosure, materials of the nozzle holder 40 and the valve holder 30 may be different, and thus, it may be lighter than the structure, in which the nozzle holder 40 and the valve holder 30 are integrally formed and costs may be reduced.

Furthermore, the valve holder 30 or the nozzle holder 40 of the present disclosure may be manufactured separately, and thus, may be used to be fitted with the valve assembly 1 according to other standards.

Meanwhile, the nozzle holder 40 may include a communication hole 40b for communicating the supply passage 30a and the nozzle passage 40a. As the valve holder 30 and the nozzle holder 40 are not integrally formed, the fluid may be leaked from a portion, at which the supply passage 30a and the nozzle passage 40a are communicated with each other.

To prevent this problem, the valve assembly 1 may include a first sealing member 90a that is configured to seal an aperture between the valve holder 30 and the nozzle holder 40. The first sealing member 90a may be provided adjacent to the communication hole 40b. The communication hole 40b may be formed on one side of the nozzle holder 40, which faces the supply passage 30a.

The nozzle holder 40 or the valve holder 30 may include a first sealing member groove 42 that accommodates the first sealing member 90a and extends to surround a through direction of the communication hole 40b.

In more detail, the nozzle holder 40 may include a support part 41 that is seated by the nozzle holder seat 15 while contacting the valve holder 30. The nozzle holder 40 may include a first sealing member groove 42 that is recessed from a support surface 41a that faces the valve holder 30 of the support part 41. That is, the first sealing member groove 42 may extend to surround the through direction of the communication hole 40b while accommodating the first sealing member 90a. For example, the first sealing member groove 42 may extend in a circumferential direction, around the through direction of the communication hole 40b.

However, the present disclosure is not limited thereto, and the first sealing member groove 42 may be formed on a lower surface of the valve holder 30, which faces the nozzle holder 40. Accordingly, the valve holder 30 may include a first sealing member groove 42 that extends to surround the through direction of the communication hole 40b.

The first sealing member 90a may be formed to extend in a circumferential direction around the through direction of the communication hole 40b, and may be accommodated in the first sealing member groove 42. The first sealing member 90a may be formed of an elastic material, and may be pressed by the valve holder 30 and the nozzle holder 40 and may be accommodated in a pressed state in the first sealing member groove 42.

A height of the communication hole 40b in an extension direction of the first sealing member groove 42, may be formed to be equal to or smaller than a diameter of the first sealing member 90a. Accordingly, when the first sealing member 90a is accommodated in the first sealing member groove 42, airtightness between the valve holder 30 and the nozzle holder 40 may be maximized.

According to this structure, the first sealing member 90a is accommodated in the first sealing member groove 42 in a pressed state, and thus, the fluid that flows through the communication hole 40b may be prevented from being leaked through the valve holder 30 and the nozzle holder 40. Furthermore, a configuration for preventing the fluid from being leaked between the nozzle holder 40 and the manifold 10 may be necessary. For this purpose, the valve assembly 1 may further include a second sealing member 90b that is provided between the manifold 10 and the nozzle holder 40 to seal an aperture between the manifold 10 and the nozzle holder 40.

The manifold 10 or the nozzle holder 40 may include a second sealing member groove 16 that accommodates the second sealing member 90b and extends to surround an extension direction of the inlet hole 11.

In more detail, the nozzle holder seat 15 may include a second sealing member groove 16 that accommodates the second sealing member 90b and extends to surround the extension direction of the inlet hole 11. Then, the second sealing member groove 16 may be recessed from a contact surface 15a of the nozzle holder seat 15 that contacts the nozzle holder 40 while contacting it. Then, the contact surface 15a may be accommodated in the second sealing member groove 16 in a state, in which the second sealing member 90b of the communication hole 40b is compressed by the nozzle holder 40 and the nozzle holder seat 15.

However, the present disclosure is not limited thereto, and the second sealing member groove 16 may be formed on a lower surface of the nozzle holder 40, which faces a contact surface 15a of the nozzle holder seat 15. Accordingly, the nozzle holder 40 may include a second sealing member groove 16 that extends to surround the extension direction of the inlet hole 11.

A height of the second sealing member groove 16 in the extension direction of the inlet hole 11 may be formed to be equal to or smaller than a diameter of the second sealing member 90b. Accordingly, when the second sealing member 90b is accommodated in the second sealing member groove 16, airtightness between the manifold 10 and the nozzle holder 40 may be maximized.

According to this structure, leakage of the fluid that flows through the communication hole 40b between the valve holder 30 and the nozzle holder 40 may be prevented by the first sealing member 90a, and leakage of the fluid between the nozzle holder 40 and an inner surface 11a of the manifold 10 may be prevented by the second sealing member 90b.

Meanwhile, a pressure received by the first sealing member 90a and the second sealing member 90b may be different. As an example, the first sealing member 90a may require airtightness under a pressure of 20 bar, and the second sealing member 90b may require airtightness under a pressure of 3 bar.

The first sealing member 90a may require airtightness against the pressure of the fluid that flows from the valve holder 30 through the communication hole 40b, and the second sealing member 90b may require airtightness against the pressure of the fluid for reuse, which is accommodated in the manifold passage 10a, and the required pressure environments may be different.

Then, forces received by the first sealing member 90a and the second sealing member 90b upward (the “Y” direction) or downward (the −Y direction) may correspond to each other. For forces that press the first sealing member 90a and the second sealing member 90b upward or downward pressure to correspond to each other but the required pressures to be different, areas, in which the first sealing member 90a and the second sealing member 90b are in contact in the first sealing member groove 42 and the second sealing member groove 16, respectively, may be different.

In more detail, the first sealing member 90a may contact the valve holder 30 and the nozzle holder 40 in a compressed state in the first sealing member groove 42 while being surrounded by them. Furthermore, the second sealing member 90b may contact the nozzle holder 40 and the nozzle holder seat 15 in a compressed state in the second sealing member groove 16 while being surrounded by them.

Then, in a cross section in FIG. 1, a surface area of the first sealing member 90a and a surface area of the second sealing member 90b may be different. In other words, an area, in which the first sealing member 90a contacts the nozzle holder 40 and the valve holder 30 in the first sealing member groove 42 may be formed to be smaller than an area, in which the second sealing member 90b contacts the nozzle holder seat 15 and the nozzle holder 40 within the second sealing member groove 16.

According to this structure, in a state, in which the valve holder 30 and the nozzle holder 40 are manufactured separately as separate components, the nozzle holder 40 is stably supported only by coupling the valve holder 30 and the manifold 10. Furthermore, even when the nozzle holder 40 and the valve holder 30 are supported in a separated state, the fluid may be prevented from being leaked through an aperture between the valve holder 30 and the nozzle holder 40 or between the nozzle holder 40 and the manifold 10.

As illustrated in FIG. 3, the first sealing member 90a may be provided in a shape that extends along a circumference of a circle, and the second sealing member 90b may be provided in a shape that extends along a circumference of an approximately rectangular shape.

The shapes of the first sealing member 90a and the second sealing member 90b are not limited thereto, and any configuration for sealing an aperture between the valve holder 30 and the nozzle holder 40 or an aperture between the nozzle holder 40 and the manifold 10 may be sufficient. For example, the second sealing member 90b may also have a shape that extends along a circumference of a circle, and the first sealing member 90a may also have a shape that extends along a rectangular circumference.

However, a size of the second sealing member 90b may be provided to be larger than a size of the first sealing member 90a. In other words, a length of a circumference of the second sealing member 90b may be configured to be larger than a length of a circumference of the first sealing member 90a. This may be because a position, in which the second sealing member 90b is inserted, is a position, in which the first sealing member 90a is inserted easier.

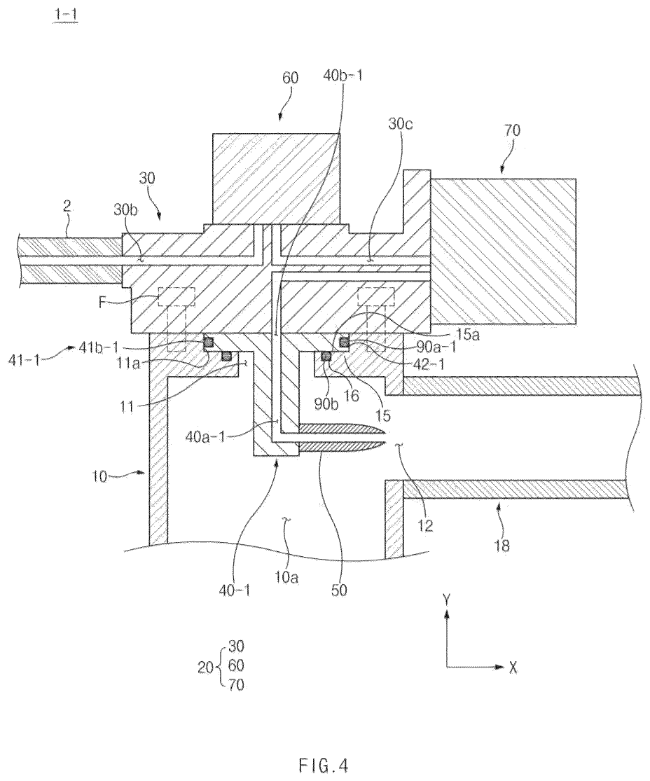

FIG. 4 is a longitudinal cross-sectional view of a valve assembly according to another embodiment of the present disclosure.

Referring to FIG. 4, the valve assembly 1-1 may have a structure, in which a position of the first sealing member 90a-1 is changed with respect to the valve assembly 1 illustrated in FIG. 1.

The first sealing member 90a-1 of the valve assembly 1-1 may be accommodated in the first sealing member groove 42-1 that is formed to be recessed from an outer surface 41b-1 of the support part 41-1, which faces a radially outer side with respect to a through direction of the communication hole 40b-1.

The first sealing member groove 42-1 may extend in a circumferential direction on an outer surface 41b-1 of the nozzle holder 40-1 toward a radially outer side with respect to the through direction of the communication hole 40b-1. According to the structure in FIG. 4, a length of a circumference of the first sealing member 90a-1 may be configured to be larger than a length of a circumference of the second sealing member 90b.

However, the present disclosure is not limited thereto, and the first sealing member groove 42-1 may be formed on the inner surface 11a of the manifold 10, which faces the outer surface 41b-1 of the nozzle holder 40-1.

Then, a depth of the first sealing member groove 42-1 in a direction that is perpendicular to the through direction of the communication hole 40b-1, may be formed to be smaller than a diameter of the first sealing member 90a-1.

Even with this structure, the first sealing member 90a-1 may be accommodated in a compressed state in the first sealing member groove 42-1, and thus, the fluid may be prevented from being leaked between the valve holder 30 and the nozzle holder 40.

Accordingly, the fluid that is supplied to the nozzle passage 40a-1 through the communication hole 40b-1 may be injected through the nozzle 50, and may be supplied to the fuel cell stack together with the fluid accommodated in the manifold passage 10a.

Secondarily, as in FIG. 1, the second sealing member 90b may prevent the fluid from being leaked between the nozzle holder 40 and the manifold 10 in a compressed state in the second sealing member groove 16.

For structures that have not described in FIG. 4, the structure in FIG. 1 is used.

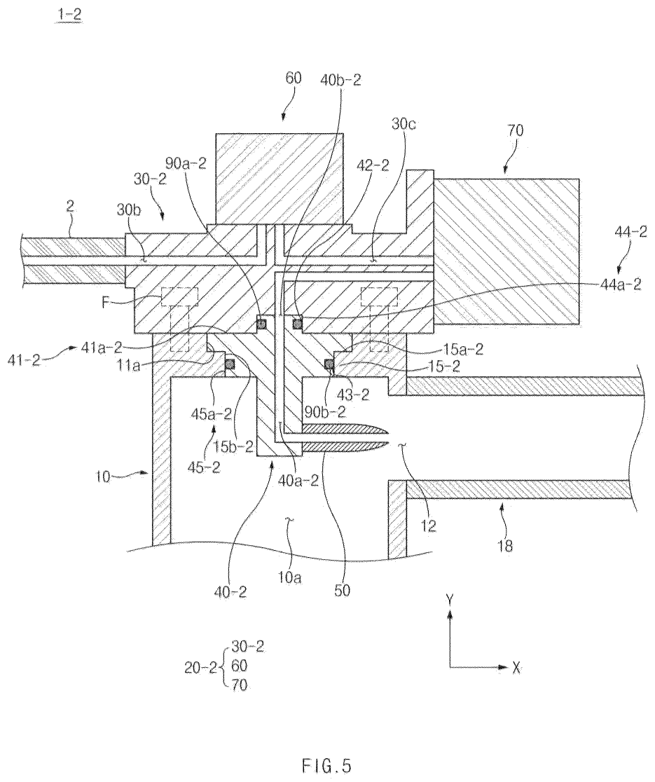

FIG. 5 is a longitudinal cross-sectional view of a valve assembly according to another embodiment of the present disclosure.

Referring to FIG. 5, a valve assembly 1-2 may have a structure, in which positions of a first sealing member 90a-2 and a second sealing member 90b-2 with respect to the valve assembly 1 of FIG. 1 are changed.

A nozzle holder 40-2 of the valve assembly 1-2 may include a guide insertion part 44-2 that protrudes toward a valve holder 30-2 of a valve module 20-2. The guide insertion part 44-2 may be formed to protrude from a support surface 41a-2 of a support part 41-2, which faces the valve holder 30-2, toward the valve holder 30.

Correspondingly, the valve holder 30-2 may have a recessed part for inserting the guide insertion part 44-2 on one side of the valve holder 30-2, which faces the nozzle holder 40-2. The recessed part may be a part that surrounds a communication hole 40b-2.

A first sealing member groove 42-2 for accommodating the first sealing member 90a-2 may be formed to be recessed from an upper outer surface 44a-2 of the guide insertion part 44-2, which faces a radially outer side with respect to a through direction of a communication hole 40b-2.

However, the present disclosure is not limited thereto, and the first sealing member groove 42-2 may be formed on an inner surface of the recessed part, which faces an upper outer surface 44a-2.

Then, a depth of the communication hole 40b-2 in a direction that is perpendicular to a through direction of the first sealing member groove 42-2, may be formed to be smaller than a diameter of the first sealing member 90a-2. The first sealing member 90a-2 accommodated in the first sealing member groove 42-2 may be compressed by the guide insertion part 44-2 and the valve holder 30-2.

Furthermore, the nozzle holder 40-2 may include a guide protrusion 45-2 that is provided on an opposite side to one side, on which the guide insertion part 44-2 is provided.

The guide protrusion 45-2 may include a lower outer surface 45a-2 that faces a radially outer side with respect to the through direction (an opposite direction to the “Y” direction) of the communication hole 40b-2 and faces a nozzle holder seat 15-2. The lower outer surface 45a-2 of the guide protrusion 45-2 may contact a vertical contact surface 15b-2 that extends downward (an opposite direction to the “Y” direction) from a horizontal contact surface 15a-2.

A second sealing member groove 43-2 for accommodating the second sealing member 90b-2 may be recessed on a lower outer surface 45a-2 of the guide protrusion 45-2, and may extend to surround a through direction of the communication hole 40b-2.

However, the present disclosure is not limited thereto, and the second sealing member groove 43-2 may be formed on a vertical contact surface 15b-2 that faces a lower outer surface 45a-2.

Then, a depth of the inlet hole 11 in the direction that is perpendicular to the extension direction of the second sealing member groove 43-2, may be formed to be smaller than a diameter of the second sealing member 90b-2. The second sealing member 90b-2 may also be compressed by the vertical contact surface 15b-2 and the nozzle holder 40-2 in the second sealing member groove 43-2.

Even with this structure, leakage of the fluid between the valve holder 30-2 and the nozzle holder 40-2 may be prevented by the first sealing member 90a-2, and leakage of the fluid between the nozzle holder 40-2 and the manifold 10 may be prevented by the second sealing member 90b-2. Furthermore, the fluid supplied to a nozzle passage 40a-2 through the communication hole 40b-2 may be sprayed through the nozzle 50, and may be supplied to the diffuser 18 together with the fluid in the manifold passage 10a to be supplied to the fuel cell stack.

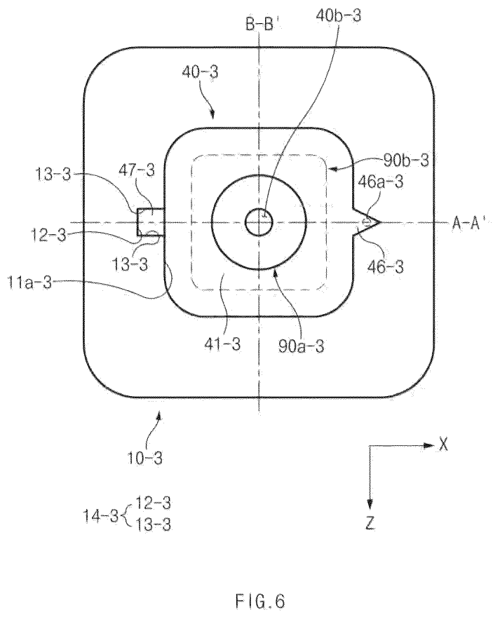

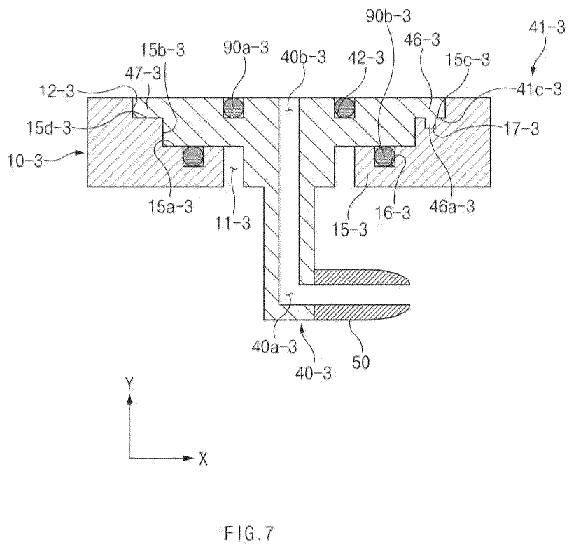

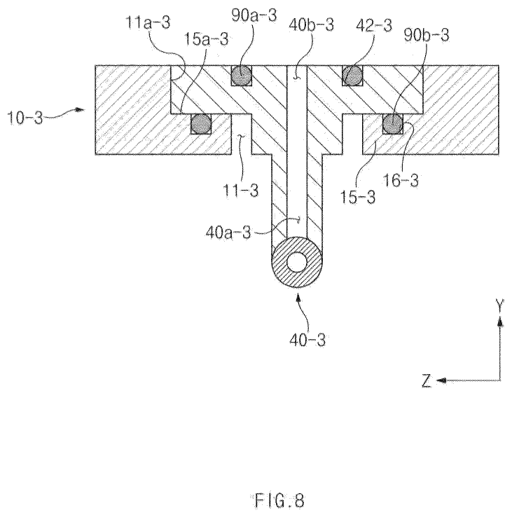

FIG. 6 is a schematic view of a nozzle holder, and a first sealing member and a second sealing member according to another embodiment of the present disclosure. FIG. 7 is a longitudinal cross-sectional view of the nozzle holder taken along line A-A′ illustrated in FIG. 6, which is seated on a manifold. FIG. 8 is a longitudinal cross-sectional view of the nozzle holder taken along line B-B′illustrated in FIG. 6, which is seated on the manifold.

Referring to FIGS. 6 to 8, a nozzle holder 40-3 may be structured to be more stably seated on a manifold 10-3. The nozzle holder 40-3 may include a communication hole 40b-3 and may support a first sealing member 90a-3 that is configured to surround the communication hole 40b-3. A second sealing member 90b-3 may be disposed between the nozzle holder 40-3 and the manifold 10-3.

A structure for guiding and seating the nozzle holder 40-3 on the manifold 10-3, a support part 41-3 of the nozzle holder 40-3 may include a guide boss 46a-3 that protrudes from a seating surface 41c-3 that faces a nozzle holder seat 15-3 toward the nozzle holder seat 15-3.

The guide boss 46a-3 may protrude from a guide boss support part 46-3 provided on one side of the support part 41-3 toward the nozzle holder seat 15-3.

The nozzle holder 40-3 may include a fixing boss 47-3 that is provided on an opposite side to one side, on which the guide boss 46a-3 is provided, with respect to the support part 41-3. The fixing boss 47-3 may protrude in a horizontal direction from an opposite side to a side, on which the guide boss 46a-3 is provided.

The fixing boss 47-3 may be a configuration for preventing the nozzle holder 40-3 from being rotated in the horizontal direction while the nozzle holder 40-3 being seated on the manifold 10-3 by the guide boss 46a-3.

The guide boss 46a-3 may be formed on a side of the support part 41-3 in a first direction (the “X” direction), and the fixing boss 47-3 may be formed on a side of the support part 41-3 in an opposite direction (the −X direction) to the first direction. The guide boss 46a-3 may protrude downward (the −Y direction) from the support part 41-3, and the fixing boss 47-3 may protrude in the horizontal direction from the support part 41-3. Accordingly, the guide boss 46a-3 and the fixing boss 47-3 may protrude from the support part 41-3 in perpendicular directions.

The nozzle holder seat 15-3 may include a first horizontal contact surface 15a-3 that defines a second sealing member groove 16-3, a vertical contact surface 15b-3 that extending upward from an outside of the first horizontal contact surface 15a-3 in parallel to a through direction of the communication hole 40b-3, a second horizontal contact surface 15c-3 and a third horizontal contact surface 15d-3 that extend from an inner surface 15b-3 to opposite sides in the horizontal direction that passes through the communication hole 40b-3.

In other words, the second horizontal contact surface 15c-3 may be provided on a side in the first direction (the “X” direction) in the horizontal direction with respect to the vertical contact surface 15b-3, and the third horizontal contact surface 15d-3 may be provided on a side in an opposite direction to the first direction (−X direction) in the horizontal direction.

The nozzle holder seat 15-3 may include a guide groove 17-3 that is configured such that the guide boss 46a-3 is inserted thereinto and is recessed on a second horizontal contact surface 15c-3. The second horizontal contact surface 15c-3 may support the guide boss support part 46-3 that is disposed on a side of the support part 41-3 in the first direction (the “X” direction).

The manifold 10-3 may include a third horizontal contact surface 15d-3 that is provided on a side of the first horizontal contact surface 15a-2 in an opposite direction to the first direction (−X direction), in which the second horizontal contact surface 15c-3 of the first horizontal contact surface 15a-3 is disposed, a pair of fixing boss surfaces 13-3 that extend upward (the “Y” direction) from the third horizontal contact surface 15d-3 and are spaced apart from each other, and a connecting surface 12-3 that connects the pair of fixing boss surfaces 13-3 and defines a fixing boss recess 14-3 together.

That is, the connecting surface 12-3 and the pair of fixing boss surfaces 13-3 may define a side surface of the fixing boss recess 14-3, and the third horizontal contact surface 15d-3 may define a bottom surface of the fixing boss recess 14-3. An inner surface 11a-3 that defines a inlet hole 11-3 may be connected to opposite sides to sides, on which the connecting surfaces 12-3 of the pair of fixing boss surfaces 13-3 are provided.

The manifold 10-3 may define a fixing boss surface 13-3 that defines a fixing boss recess 14-3, into which the fixing boss 47-3 is inserted, and is formed to prevent rotation of the fixing boss 47-3.

When the fixing boss 47-3 is inserted into the fixing boss recess 14-3, fixing boss surfaces 13-3 may be provided on opposite sides in the circumferential direction with respect to the guide boss 46a-3. Then, because the fixing boss surfaces 13-3 support opposite sides of the fixing boss 47-3, rotation of the fixing boss 47-3 may be prevented by the fixing boss surfaces 13-3.

That is, when the fixing boss 47-3 is inserted into the fixing boss recess 14-3, the guide boss 46a-3 becomes a rotation axis, and the nozzle holder 40-3 may be prevented from being rotated on the manifold 10-3.

As illustrated in FIGS. 7 and 8, the second horizontal contact surface 15c-3 and the third horizontal contact surface 15d-3 of the manifold 10-3 may be provided on a cross-section in the first direction (the “X” direction) in the horizontal direction that crosses the inlet hole 11-3 of the manifold 10-3, and may not be provided on a cross-section in the second direction (the “Z” direction) in the horizontal direction that is perpendicular to the first direction.

Accordingly, the guide boss 46a-3 of the nozzle holder 40-3 has a structure that may be inserted only into the guide groove 17-3, and thus, the nozzle holder 40-3 may be more stably attached to the manifold 10-3, and the fluid that is delivered to the nozzle passage 40a-3 through the communication hole 40b-3 may be injected through the nozzle 50.

Furthermore, leakage of the fluid between the nozzle holder 40-3 and the valve holder 30 (see FIG. 1) may be prevented by the first sealing member 90a-3 accommodated in the first sealing member groove 42-3 and the second sealing member 90b-3 accommodated in the second sealing member groove 16-3.

Among the above-described structures, structures that have not been described may be understood as the same as those disclosed in FIG. 1.

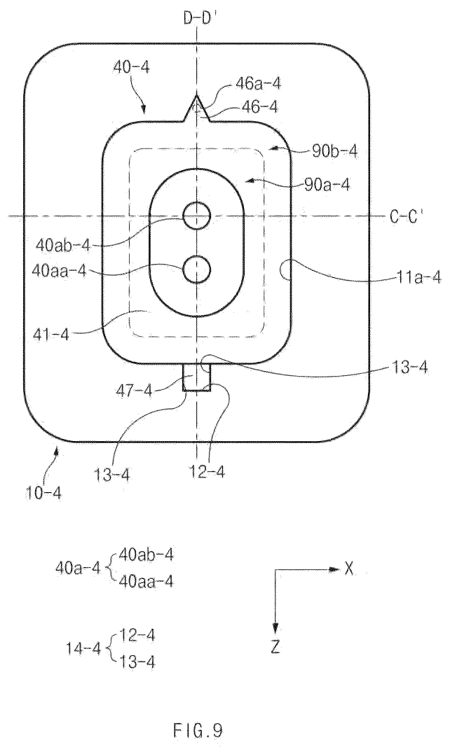

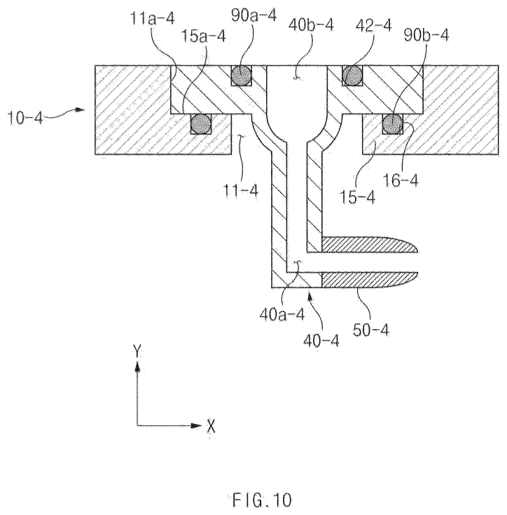

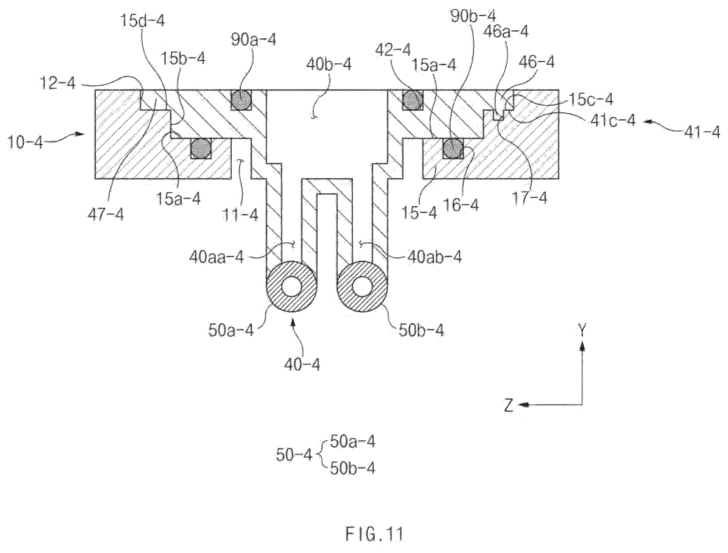

FIG. 9 is a schematic view of a nozzle holder, and a first sealing member and a second sealing member according to another embodiment of the present disclosure. FIG. 10 is a longitudinal cross-sectional view of the nozzle holder taken along line C-C′ illustrated in FIG. 9, which is seated on a manifold. FIG. 11 is a longitudinal cross-sectional view of the nozzle holder taken along line D-D′ illustrated in FIG. 9, which is seated on the manifold.

Referring to FIGS. 9 to 11, a plurality of nozzles 50-4 may be mounted on a nozzle holder 40-4, unlike the nozzle holder 40-3 of FIG. 6. In more detail, the plurality of nozzles 50-4 may include a first nozzle 50a-4 that is coupled to the nozzle holder 40-4, and a second nozzle 50b-4 that is distinguished from the first nozzle 50a-4.

The nozzle holder 40-4 may include a first nozzle passage 40aa-4 that is communicated with the supply passage 30a (see FIG. 1) to deliver the fluid to the first nozzle 50a-4, and a nozzle passage 40a-4 that is provided as a second nozzle passage 40ab-4 for delivering the fluid to the second nozzle 50b-4.

The nozzle holder 40-4 may include a communication hole 40b-4, and may support a first sealing member 90b-4 that is configured to surround the communication hole 40b-4. A second sealing member 90b-4 may be disposed between the nozzle holder 40-4 and a manifold 10-4.

Like the above-described nozzle holder 40-3 (see FIG. 6), the nozzle holder 40-4 may include a guide boss 46a-4 that is provided on one side of a support part 41-4 in the horizontal direction, and a fixing boss 47-4 that is provided on an opposite side of a guide boss support part 46-4 and the support part 41-4 in the horizontal direction. The guide boss 46a-4 may protrude from a seating surface 41c-4 of the support part 41-4 toward a nozzle holder seat 15-4.

The nozzle holder seat 15-4 may include a first horizontal contact surface 15a-4 that defines a second sealing member groove 16-4, a vertical contact surface 15b-4 that extends from an outside of a first contact surface 15a-4 in an upward direction (the “Y” direction) of the communication hole 40b-4, respectively, and a second horizontal contact surface 15c-4 and a third horizontal contact surface 15d-4 that extend from the vertical contact surface 15b-4 in the second direction (the “Z” direction) or an opposite direction to the second direction (the “Z” direction) in the horizontal direction that crosses the communication hole 40b-4.

As illustrated in FIGS. 10 and 11, the second horizontal contact surface 15c-4 and the third horizontal contact surface 15d-4 of the manifold 10-4 may be provided only in a second direction (the “Z” direction) that is perpendicular to the first direction (the “X” direction) in the horizontal direction that passes through the inlet hole 11-4 or an opposite direction to the second direction. However, the present disclosure is not limited thereto, and it is sufficient as long as the second horizontal contact surface 15c-4 and the third horizontal contact surface 15d-4 are provided on opposite sides with respect to the inlet hole 11-4.

The nozzle holder seat 15-4 may include a guide groove 17-4 that is configured such that the guide boss 46a-4 is inserted thereinto and is recessed on the second horizontal contact surface 15c-4. The second horizontal contact surface 15c-4 may support the guide boss support part 46-4.

The manifold 10-4 may include a third horizontal contact surface 15d-4 that is provided on an opposite side to one side, on which the second horizontal contact surface 15c-4 is disposed, with respect to the first horizontal contact surface 15a-4, a pair of fixing boss surfaces 13-4 that extend upward (the “Y” direction) from the third horizontal contact surface 15d-4 and are spaced apart from each other, and a connecting surface 12-4 that connects the pair of fixing boss surfaces 13-4 and defines a fixing boss recess 14-4 together.

That is, the connecting surface 12-4 and the pair of fixing boss surfaces 13-4 may define a side surface of the fixing boss recess 14-4, and the third horizontal contact surface 15d-4 may define a bottom surface of the fixing boss recess 14-3. Opposite sides of sides of the pair of fixing boss surfaces 13-4, which are connected to the connecting surface 12-4, may be connected to the inner surface 11a-4 that defines the inlet hole 11-4.

The manifold 10-4 forms a fixing boss surface 13-4 that defines a fixing boss recess 14-4, into which the fixing boss 47-4 is inserted, and is formed to prevent rotation of the fixing boss 47-4.

When the fixing boss 47-4 is inserted into the fixing boss recess 14-4, fixing boss surfaces 13-4 may be provided on opposite sides of the fixing boss 47-4 in the circumferential direction with respect to the guide boss 46a-4. Then, because the fixing boss surfaces 13-4 support opposite side surfaces of the fixing boss 47-4, rotation of the fixing boss 47-4 may be prevented by the fixing boss surfaces 13-4.

That is, when the fixing boss 47-4 is inserted into the fixing boss groove (14-4), the nozzle holder 40-4 may be prevented from being rotated on the manifold 10-4 while the guide boss 46a-4 is taken as a rotational axis thereof.

According to this structure, due to the structures of a first sealing member 90a-4 accommodated in the first sealing member groove 42-4 and the second sealing member 90b-4 accommodated in the second sealing member groove 16-4, leakage of the fluid may be prevented, and the fluid delivered to the first nozzle passage 40aa-4 and the second nozzle passage 40ab-4 through the communication hole 40b-4 may be supplied to the fuel cell stack through the first nozzle 50a-4 and the second nozzle 50b-4.

In relation to the structure, in which a plurality of nozzles 50-4 are provided, a speed of the fluid sprayed through a nozzle 50-4 may be relatively high when a cross-sectional area of the discharge hole of the nozzle 50-4 is small, and in this case, an amount of the fluid supplied to the fuel cell stack may be relatively decreased.

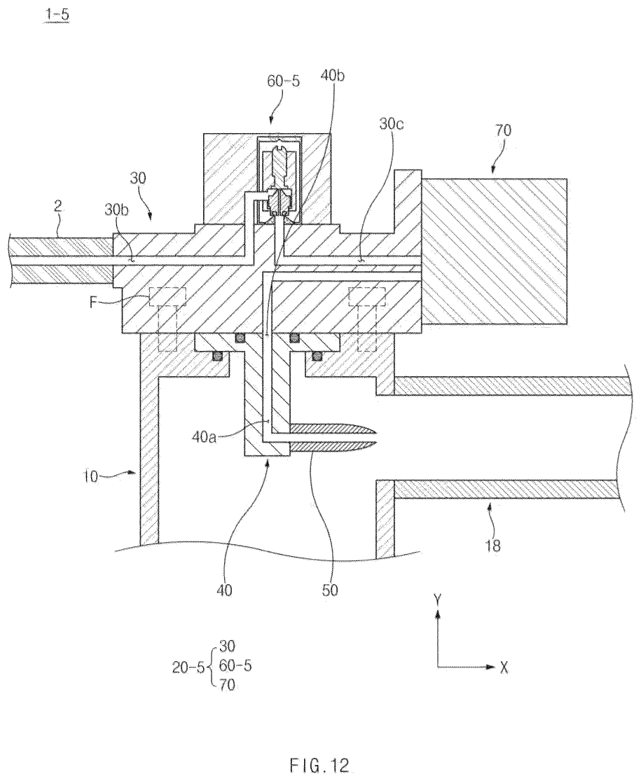

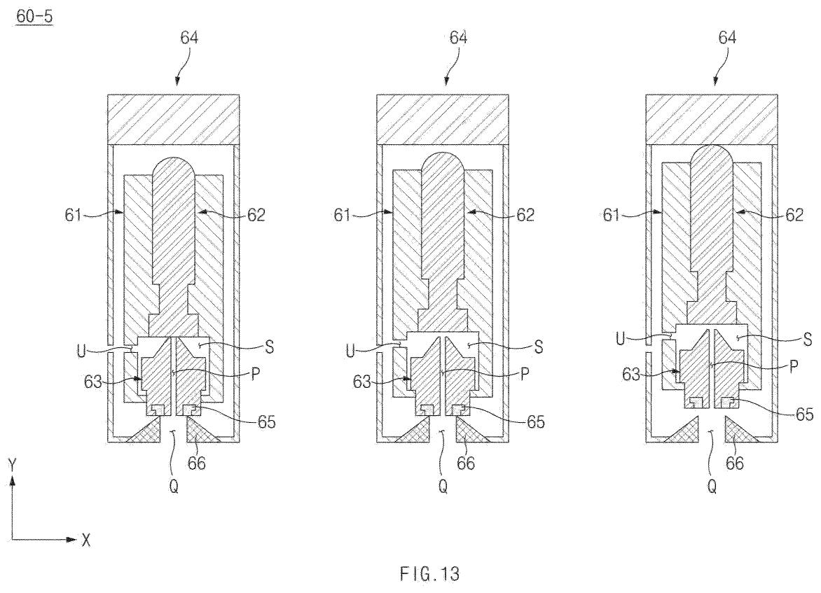

To maintain the speed of the fluid supplied to the fuel cell stack and increase the amount of the fluid supplied to the fuel cell stack, a plurality of nozzles 50-4 may be provided, and even under this structure, the valve holders 30 and 30-2 illustrated in FIGS. 1 to 8 may be used as they are, and thus the valve assembly 1, 1-1, and 1-2 in the present disclosure may have an improved usability. That is, the valve holder 30 or the nozzle holder 40 manufactured in the same way may be used in fuel cell vehicles of various sizes, and thus, manufacturing costs may be reduced and productivity may also be improved. FIG. 12 is a longitudinal cross-sectional view of a valve assembly according to another embodiment of the present disclosure. FIG. 13 is a schematic view of a cutoff valve illustrated in FIG. 12.

Referring to FIGS. 12 and 13, a valve assembly 1-5 has a structure corresponding to the valve assembly 1 illustrated in FIG. 1, except for a cutoff valve 60-5 of a valve module 20-5.

Unlike the present disclosure, according to a structure, in which a plurality of valves are coupled to the valve holder in series in the horizontal direction, a length of a passage in an interior of the valve holder may be relatively long and a cross-sectional area of the passage may also be increased.

In this way, the length of the passage and the cross-sectional area of the passage increase, and thus, a size of the cutoff valve may also be made large. In contrast, according to the present disclosure, the cutoff valve 60-5 may be provided in a relatively small size.

In more detail, the cutoff valve 60-5 may be provided between the first supply passage 30b and the second supply passage 30c, and when the fluid is supplied to the fuel cell stack, the first supply passage 30b and the second supply passage 30c can be communicated with each other, and when the fluid is not supplied to the fuel cell stack, a space between the first supply passage 30b and the second supply passage 30c may be closed.

As an example, the cutoff valve 60-5 may be provided as a solenoid valve 60-5. In more detail, the solenoid valve 60-5 may be a configuration for opening or closing a passage in an interior of the solenoid valve 60-5 by controlling magnetic fields through current that flows in a coil (not illustrated) to move a plunger 61.

The solenoid valve 60-5 may include a damper member 62 for preventing the plunger 61 from colliding with a core part 64 as it moves in a downward direction (an opposite to the “Y” direction) or an upward direction (the “Y” direction) of the plunger 61, and a pilot member 63 that is provided in a vertical direction (an opposite direction to the “Y” direction) of the plunger 61 and has a pilot passage “P”.

Furthermore, the solenoid valve 60-5 may further include the core part 64 that is provided to face the damper member 62 and is configured to contact the damper member 62 when the plunger 61 is moved toward the damper member 62. The core part 64 may be a configuration for increasing a driving efficiency of the solenoid valve 60-5 by delivering the magnetic fields generated by the current of the coil (not illustrated) to the plunger 61. Accordingly, the plunger 61 may be a magnetic body that may be magnetized by a magnetic field.

Meanwhile, a sealing part 65 may be formed in an area that faces an orifice member 66 provided adjacent to a second supply passage 30b. Furthermore, a through passage “U” that communicates an interior space “S” and the first supply passage 30a may be formed on one side surface of the plunger 61.

When a magnetic field is formed around the core (not illustrated) by current in a state, in which the plunger 61 is spaced downward (an opposite direction to the “Y” direction) apart from the core part 64 and the damper member 62 is attached to the pilot member 63, the plunger 61 is moved upward (the “Y” direction) due to a magnetic force, and the damper member 62 is spaced upward (the “Y” direction) apart from the pilot member 63. Accordingly, the fluid introduced into the through passage “U” is introduced into the pilot passage “P” of the pilot member 63, and flows downward (the −Y direction) through a communication passage “Q”.

Meanwhile, as the pilot passage “P”, the communication passage “Q”, and a lower side (the −Y direction) thereof are filled with the fluid, a force that is applied by the fluid to the solenoid valve 60-5 including the pilot member 63 in the upward direction (the “Y” direction) increases. The pilot member 63 and the plunger 61 may be further moved so that the pilot member 63 and the orifice member 66 are spaced apart from each other, and the fluid may be additionally introduced through the space between the pilot member 63 and the orifice member 66.

According to this principle, the solenoid valve 60-5 may have a structure, in which the orifice member 66 is opened when the second supply passage 30c and the first supply passage 30b are provided with the same pressure.

According to this structure, when a cross-sectional area of the second supply passage 30c between the solenoid valve 60-5 and the flow rate control valve 70 is large, a time period from a time point, at which an electrical signal is applied to the solenoid valve 60-5 to a time point, at which the solenoid valve 60-5 opens and closes the passage may be long, whereas according to the valve holder 30 in the present disclosure, a cross-sectional area of the second supply passage 30c may be reduced, and as a result, the solenoid valve 60-5 may be made small in size, and usability may be improved.

According to the above-described structure, because the valve holders 30 and 30-2 and the nozzle holders 40, 40-1, 40-2, 40-3, and 40-4 of the valve assemblies 1, 1-1, 1-2, and 1-5 may be manufactured individually rather than integrated, usability may be improved by replacing or providing at least one of the valve holders 30 and 30-2 and the nozzle holders 40, 40-1, 40-2, 40-3 and 40-4.

A space between the valve holder 30 and 30-2 and the nozzle holder 40, 40-1, 40-2, 40-3, and 40-4 or between the nozzle holder 40, 40-1, 40-2, 40-3, and 40-4 and the manifold 10, 10-3, and 10-4 may be airtight at the same time, and thus, sealing of the valve assembly 1, 1-1, 1-2, and 1-5 may be improved.

In addition, compared to a structure, in which a plurality of valves are arranged in series in the valve assembly 1, 1-1, 1-2, and 1-5, a size of the valve holder 30 and 30-2 may be relatively small, and a size of the cutoff valve 60 and 60-5 may be configured to be small at the same time, and thus, productivity may be improved.

According to this technology, because the valve holder and the nozzle holder are manufactured separately and the valve holder and the nozzle holder are mounted on the manifold, the same valve holder or nozzle holder may be used in various fuel cell systems with one valve holder or one nozzle holder whereby usability may be improved.

Furthermore, according to this technology, even though the valve holder and the nozzle holder are manufactured separately, the nozzle holder may be more stably fixed to the manifold.

In addition, according to this technology, the fluid may be prevented from being leaked between the valve holder and the nozzle holder as the valve holder and the nozzle holder are coupled to each other.

In addition, various effects that may be directly or indirectly recognized through the present disclosure may be provided.

The above description is a simple exemplary description of the technical spirits of the present disclosure, and an ordinary person in the art, to which the present disclosure pertains, may make various corrections and modifications without departing from the essential characteristics of the present disclosure.

Therefore, the embodiments disclosed in the present disclosure are not for limiting the technical spirits of the present disclosure but for describing them, and the scope of the technical spirits of the present disclosure is not limited by the embodiments. The protection scope of the present disclosure should be construed by the following claims, and all the technical spirits in the equivalent range should be construed as being included in the scope of the present disclosure.

What is claimed is:

1. A valve module for a vehicle, the valve module comprising:
a valve holder including a supply passage, through which fluid flows from an inlet, into which the fluid is supplied;
a cutoff valve coupled to the valve holder, and configured to prevent or allow flow of the fluid through the supply passage; and
a flow rate control valve coupled to the valve holder, and configured to control a flow rate of the fluid that flows through the supply passage.

2. The valve module of claim 1, wherein the flow rate control valve is disposed on a downstream side of the cutoff valve with respect to a flow direction of the fluid that flows through the supply passage.

3. The valve module of claim 1, wherein any one of the cutoff valve or the flow rate control valve is formed on an opposite side to one side, on which the inlet of the valve holder is provided.

4. The valve module of claim 1, wherein the cutoff valve is coupled to the valve holder along a first coupling axis, and
wherein the flow rate control valve is coupled to the valve holder along a second coupling axis crossing the first coupling axis.

5. The valve module of claim 4, wherein a direction of the first coupling axis is perpendicular to a direction of the second coupling axis.

6. The valve module of claim 1, wherein a volume of a portion of the supply passage between the cutoff valve and the flow rate control valve is configured to be smaller than 20 ml.

7. A valve assembly for a vehicle, the valve assembly comprising:
a manifold;
a valve holder coupled to the manifold;
a nozzle holder seated in the manifold between the valve holder and the manifold;
a coupling member configured to couple the valve holder to the manifold; and
a first sealing member configured to seal an aperture between the valve holder and the nozzle holder.

8. The valve assembly of claim 7, wherein the manifold includes:
an inlet hole, into which the nozzle holder is inserted; and
a nozzle holder seat protruding from an inner surface extending along a circumference of the inlet hole toward a center of the inlet hole, and configured to support the nozzle holder.

9. The valve assembly of claim 7, wherein the valve holder includes a supply passage provided in an interior of the valve holder such that fluid flows therethrough,
wherein the nozzle holder includes:
a nozzle passage communicated with the supply passage and configured to deliver the fluid to the nozzle coupled to the nozzle holder; and
a communication hole configured to communicate the supply passage and the nozzle passage, and
wherein the nozzle holder or the valve holder includes:
a first sealing member groove accommodating the first sealing member, and extending to surround a through direction of the communication hole.

10. The valve assembly of claim 9, wherein the first sealing member groove is configured to be recessed from a support surface of the nozzle holder, which faces the valve holder.

11. The valve assembly of claim 7, further comprising:
a second sealing member provided between the manifold and the nozzle holder, and configured to seal an aperture between the manifold and the nozzle holder.

12. The valve assembly of claim 11, wherein the manifold includes an inlet hole, into which the nozzle holder is inserted, and
wherein the nozzle holder or the manifold includes a second sealing member groove accommodating the second sealing member and extending to surround an extension direction of the inlet hole.

13. The valve assembly of claim 12, wherein the manifold includes a nozzle holder seat protruding from an inner surface of the manifold, which extends along a circumference of the inlet hole, toward a center of the inlet hole and configured to support the nozzle hole, and
wherein the second sealing member groove is formed to be recessed from a contact surface supporting the nozzle holder of the nozzle holder seat.

14. A vehicle comprising the valve assembly of claim 7.

15. The valve assembly of claim 7, wherein the coupling member is inserted into the manifold while passing through the valve holder.

16. The valve assembly of claim 7, wherein a plurality of coupling members are provided to be coupled to four corner areas of the valve holder when viewed from a top.

17. The valve assembly of claim 7, wherein the valve holder includes a supply passage provided in an interior of the valve holder such that the fluid flows therethrough, and
wherein the valve assembly further includes:
a cutoff valve coupled to the valve holder and configured to prevent or allow flow of the fluid through the supply passage; and
a flow rate control valve coupled to the valve holder, and configured to control a flow rate of the fluid that flows through the supply passage.

18. The valve assembly of claim 8, wherein the nozzle holder includes a guide boss protruding from a seating surface of the nozzle holder, which faces the nozzle holder seat, toward the nozzle holder seat, and
wherein the nozzle holder seat includes a guide groove configured such that the guide boss is inserted thereinto.

19. The valve assembly of claim 18, wherein the nozzle holder includes a fixing boss protruding from an opposite side to one side, on which the guide boss is provided, in a horizontal direction, and
wherein the manifold includes a fixing boss surface defining a fixing boss recess, into which the fixing boss is to be inserted, and configured to prevent rotation of the fixing boss.

20. The valve assembly of claim 7, wherein the valve holder includes a supply passage provided in an interior of the valve holder such that the fluid flows therethrough,
wherein the nozzle holder includes a nozzle passage communicated with the supply passage and configured to deliver the fluid to a first nozzle and a second nozzle coupled to the nozzle holder, and
wherein the nozzle passage includes a first nozzle passage configured to deliver the fluid to the first nozzle and a second nozzle passage configured to deliver the fluid to the second nozzle.
